(19) United States
(12) Patent Application Publication
(10) Pub. No.: US 2018/0147756 A1
(43) Pub. Date: May 31, 2018

(54) METHOD FOR THE PRODUCTION OF AN INSERT FOR AN OPENING PANEL OF A MOTOR VEHICLE

(71) Applicants: David TRESSE, Saint-Andre de Corcy (FR); Emilien HUMMER, Villeurbanne (FR); Issam KHAYAT, Lyon (FR); Jean-Francois PRAT, Villeurbanne (FR)

(72) Inventors: David TRESSE, Saint-Andre de Corcy (FR); Emilien HUMMER, Villeurbanne (FR); Issam KHAYAT, Lyon (FR); Jean-Francois PRAT, Villeurbanne (FR)

(21) Appl. No.: 15/564,002

(22) PCT Filed: Apr. 1, 2016
(86) PCT No.: PCT/FR2016/050737

§ 371 Date: Oct. 3, 2017

(30) Foreign Application Priority Data
Apr. 3, 2015 (FR) 1552915

(51) Int. Cl. B29C 45/00; B29C 63/00; B29C 70/32; B29C 70/52

(52) U.S. Cl. CPC B29C 45/0005; B29C 63/0026; B29C 45/14631; B29C 70/525; B29C 70/32

(57) ABSTRACT

An elongate element is formed from a composite material and a coil is formed by winding the elongate element around a master model. The master model provides the coil with the general shape of a continuous ring and with dimensions that allow the resulting coil to form an insert equipped with at least two parts that are intended to extend respectively through at least two separate opening panel zones to be reinforced.

### FIELD OF THE INVENTION

This invention relates to a method for the production of a reinforcement insert for an opening panel of a motor vehicle.

It applies more particularly to the production of inserts for motor vehicle rear opening panels, generally called tailgates.

### BACKGROUND OF THE INVENTION

A motor vehicle tailgate is generally made of a metal such as steel. To reduce the weight of the opening panel, it is known to make it partly from composite material comprising at least one polymer, for example thermoplastic.

However, in an opening panel, some zones are more subject to mechanical stresses, for example the zones supporting some items of equipment of the opening panel, such as a lock, means for pivoting the opening panel, means for anchoring means for assisting the operation of the opening panel, etc.

If an opening panel is made partly of composite material, it is known to reinforce the zones that are more subject to mechanical stresses by placing metal inserts in a mold intended to form the opening panel and injecting a material comprising at least one polymer into the mold, the inserts being positioned in the zones of the mold intended to form the zones to be reinforced.

### SUMMARY OF THE INVENTION

The invention aims to further reduce the weight of an opening panel, more particularly an opening panel made of composite material, by replacing the metal inserts by lighter reinforcing means with suitable mechanical properties that are easy to manufacture.

The invention therefore relates to a method for the production of an insert for a motor vehicle opening panel, wherein an elongate element is formed from a composite material and a coil is formed by winding the elongate element around a master model, the master model providing the coil with the general shape of a continuous ring and with dimensions that allow the resulting coil to form an insert equipped with at least two parts that are intended to extend respectively through at least two separate opening panel zones to be reinforced.

According to the embodiments, the two parts of the insert are either two zones of the same insert in one piece, or two sections formed by cutting a single insert.

The insert, produced according to the method according to the invention, is made of composite material. It is therefore lighter than the metal inserts. Since it is made essentially by simply winding, it is compatible with the manufacturing speed and cost requirements of the automotive industry.

The simple and continuous winding of the elongate element of composite material on a master model avoids complex positioning and/or pivoting of the elements forming the insert. In addition, it simplifies the deposition of the elongate element compared with localized positioning of reinforcing elements deposited in pieces directly on the panel. The production method proposed is therefore very easy to implement.

Continuous winding is understood to mean that the elongate element deposited consists preferably of a single piece throughout the winding. Note that the elongate element can thus be wound by going several times around the master model. If the winding is interrupted at the end of a turn, the winding of the next turn should preferably start at a position other than that where the previous turn was interrupted.

Consequently, there is no need to plan expensive equipment to make and control complex movements. The costs related to the production method according to the invention are therefore low.

By choosing a master model having a contour substantially coinciding with the required path of the insert in the opening panel, the insert can be given all the shapes required to adapt to the usual more or less complex shapes of the opening panels and molds used for their production.

According to a particular embodiment, the elongate element is wound around the master model by turning the master model with respect to means for applying the elongate element on the master model.

The master model can either be rotated about itself, the application means remaining fixed, or the application means can be moved around a fixed master model, or both at the same time.

If the application means remain fixed, the master model can be rotated about itself at a variable angle with respect to the application means to facilitate deposition.

This allows the elongate element to be applied accurately and quickly with no need for complex means to position it.

According to a particular embodiment, the elongate element is shaped by pultrusion through a die for shaping the cross-section of the elongate element.

Pultrusion is a simple and efficient production method used to give a composite material an elongate shape.

Advantageously, the cross-section of the elongate element which is wound on the master model to create reinforcing parts alternating with connecting parts in the insert is varied, the reinforcing parts being intended to extend through the opening panel zones to be reinforced, the connecting parts being thinner than the reinforcing parts.

An elongate element of variable cross-section may be provided for example by tapes of fibers impregnated by a matrix material when they are deposited on the master model, the variation in cross-section being obtained by superimposing and/or folding the tapes.

Note that the elongate element will preferably be given a cross-section that allows it to be removed easily from the master model, such as open cross-sections, for example I-, L- or V-shaped cross-sections, having a suitable draft.

Optionally, the fiber tapes can be pre-impregnated before being deposited on the master model, more matrix being added if necessary when applying these tapes on the master model.

According to a particular embodiment resulting from a compromise between the lightness and mechanical strength of the insert, the composite material comprises a reinforcing material embedded in a matrix, for example a reinforcing material of glass or carbon fibers embedded in a polyimide matrix.

According to a particular embodiment, the insert is cut off in order to separate the two parts that are intended to extend through the two zones to be reinforced.

Preferably, the orientation of a surface defining the cross-section of the elongate element around a neutral fiber of this elongate element is varied so that this surface is intended to extend through the opening panel zones to be reinforced with different orientations. This variation in the orientation of the surface is carried out while winding the elongate element on the master model.

Advantageously, this allows the surface to be oriented according to the stresses to which the reinforcement will be subjected.

According to a particular embodiment, the elongate element having a polygonal cross-section, for example rectangular, the orientation of the sides of this elongate element is varied so that the sides are intended to extend through the opening panel zones to be reinforced with different orientations.

The invention also relates to a method for the production of a motor vehicle opening panel made of composite material, this opening panel comprising a body overmolded on an insert, wherein
an insert made of composite material is formed using a method according to the invention;
the insert or parts of the insert are placed in a mold; and
a material comprising at least one polymer is distributed, preferably by injection, in the mold to form the body overmolded on the insert.

This method is therefore used to obtain a motor vehicle opening panel by overmolding the insert made by the production method according to the invention, which is a fast and inexpensive manufacturing technique, and therefore compatible with the speed and cost requirements of the automotive industry.

More particularly, the method for the production of a motor vehicle opening panel according to the invention can be applied to the production of a tailgate.

The invention also relates to an installation for the production of an insert of a motor vehicle opening panel, wherein it comprises:
means for supplying an elongate element made of composite material; and
means for winding the elongate element around a master model, the master model having a shape and dimensions to provide the wound elongate element with the general shape of a continuous ring and with dimensions that allow the wound elongate element to form an insert intended to extend through at least two separate opening panel zones to be reinforced.

This installation requires no expensive means and therefore reduces investment costs. It also allows fast manufacturing.

Note that the supply means can either be shaping means or means for simple distribution of an elongate element made of composite material.

According to a particular embodiment, the winding means comprise means for applying the elongate element on the master model and means for driving in rotation the master model with respect to these means for applying the elongate element on the master model.

This allows the elongate element to be applied accurately and quickly with no need for complex means to position it.

In a particular embodiment that is easy to implement, the application means comprise a roller for guiding and applying the elongate element on the master model.

In a particular embodiment, the installation further comprises a robot for carrying the master model, the means for driving in rotation the master model being formed by a part of an arm of the robot.

The invention also relates to an installation for the production of a motor vehicle opening panel, wherein it comprises an installation for the production of an insert according to the invention and:
a mold in which the insert is to be placed; and
means for distributing material comprising at least one polymer in the mold, preferably injection means.

The invention also relates to a motor vehicle opening panel made of composite material, wherein it comprises an insert made of composite material comprising a reinforcing material embedded in a matrix, the insert having the general shape of a continuous ring extending through at least two separate opening panel zones to be reinforced.

Advantageously, the opening panel includes a window, the insert surrounds the window.

Lastly, the invention relates to a motor vehicle opening panel according to the invention, this opening panel forming a tailgate of the vehicle and comprising at least two separate zones to be reinforced forming support means selected from:
locking means;
pivoting means; and
means for anchoring means for assisting the operation of the opening panel.

### BRIEF DESCRIPTION OF THE DRAWINGS

The invention will be better understood on reading the accompanying figures, which are given solely by way of example and not limiting in any way, in which:

FIG. 1 is a front view of a motor vehicle tailgate panel comprising a composite insert according to the invention;

FIG. 2 is a side view of the tailgate and the insert of FIG. 1;

FIG. 3 is a schematic front view of a part of an installation according to the invention;

FIG. 4 is a perspective view of a robot of the installation according to the invention;

FIG. 5 is a perspective view of a detail of a composite insert according to the invention;

FIG. 6 is a schematic front view of molding means of the installation according to the invention.

### DETAILED DESCRIPTION

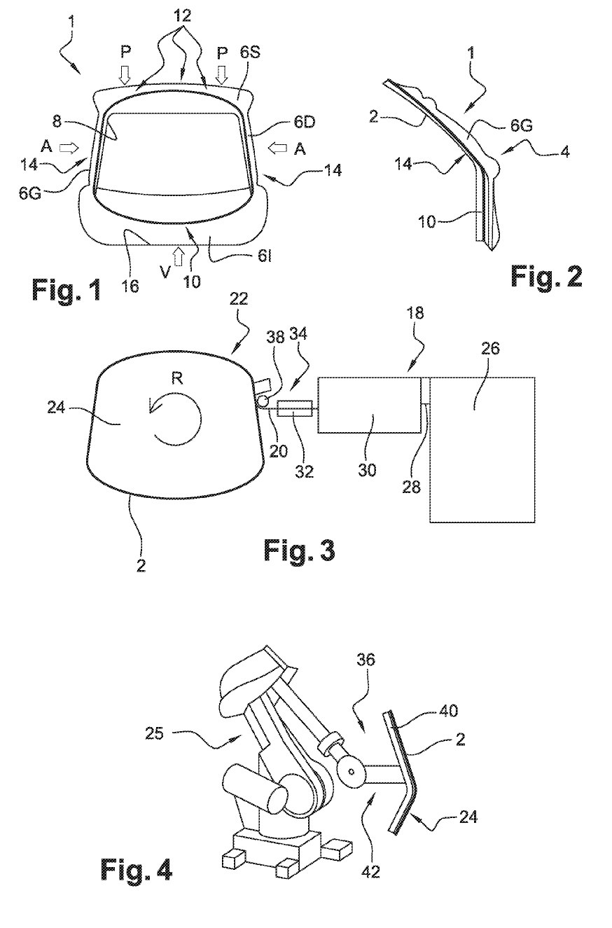

FIGS. 1 and 2 show a motor vehicle opening panel 1 made of composite material. This panel 1 comprises an insert 2 extending in a body 4 made of a conventional material comprising at least one polymer. The body 4 is overmolded on the insert 2.

The opening panel is more particularly a tailgate for closing a rear opening of a motor vehicle body.

Note that the insert 2 is shown on FIGS. 1 and 2 although it is partly or wholly embedded in the body 4.

The tailgate panel 1 comprises a lower side wall 61, a left side upright 6G, an upper wall 6S and a right side upright 6D. These walls and elements define an opening 8 of the tailgate.

The insert 2 extends through at least two separate zones to be reinforced of the panel 1. The tailgate (and therefore the panel) comprises, in this example, five zones to be reinforced, each forming a support for an item of equipment of the tailgate panel 1. These items of equipment, not shown for reasons of clarity, are in particular:
locking means acting as a lock for the motor vehicle tailgate,
pivoting means for the tailgate, especially hinges, to pivot it relative to the motor vehicle body during operation, and
means for anchoring means for assisting the operation of the tailgate, such as tailgate opening and/or closing assistance struts.

In FIG. 1, arrow V indicates the position of the locking means, arrows P indicate the position of the hinge means for the pivoting of the tailgate, and arrows A indicate the position of the means for anchoring means for assisting the operation of the tailgate opening panel 1.

This example therefore shows a zone 10 to be reinforced used to support the lock of the tailgate panel 1, which is located on a lower wall 61 of the tailgate 1 opposite the arrow V. More precisely, this zone 10 to be reinforced is located half way along the lower wall 6 and at the outer edge 16 of the lower wall 61.

This example also shows two zones 12 to be reinforced, each acting as support for a hinge of the tailgate 1, which are located on the upper wall 6S of the tailgate 1 opposite arrows P. More precisely, the zones 12 to be reinforced are located at two points of the upper wall 12 of the tailgate, symmetrically with respect to an axis of symmetry of the tailgate 1.

Lastly, this example shows two separate zones 14 to be reinforced each acting as support for means for anchoring means for assisting the operation of the tailgate 1, which are located respectively on the left side upright 6G and the right side upright 6D opposite the arrows A.

It will be understood that the zones 10, 12 and 14 to be reinforced are zones to be reinforced to withstand certain forces related to the presence of the equipment mentioned above.

Note that the insert 2 has the general shape of a continuous ring extending through at least two separate zones to be reinforced of the tailgate. Preferably, the insert 2 extends through all the locking 10, pivoting 12 and anchoring 14 zones to be reinforced.

The insert 2 is made of composite material, more particularly a composite material comprising a reinforcing material embedded in a matrix. Preferably, the reinforcing material is composed of glass or carbon fibers, and the matrix is made of a polymer material, preferably thermoplastic, such as polyamide.

The body 4 is preferably made of thermoplastic polymer material, which is both light and easy to shape, preferably by injection molding.

FIGS. 3 and 4 show parts of an example of an installation according to the invention for the production of the insert 2.

The installation comprises means 18 for supplying an elongate element 20 made of composite material and means 22 for winding this elongate element 20 on a master model 24 shown on FIG. 3, and a robot 25 shown on FIG. 4.

The supply means 18 are either means for forming the elongate element 20, or means for distributing this elongate element 20.

In the example illustrated, the supply means are means for forming by pultrusion.

They may therefore comprise means 26 for continuously supplying a reinforcing material in the form of a tape 28, such as glass or carbon fibers. The supply means 26 are not shown in detail, being known as such.

The tape of reinforcing material is then conveyed to the means 30 for impregnating the tape 28 with a matrix, for example by passing through a bath filled with this matrix heated to its melting point. Preferably, this matrix comprises a thermoplastic polymer material such as resin or polyamide.

The impregnated tape 28 is then moved by means known as such (not shown) through a die 32, the melting point of the matrix being maintained by conventional heating means not shown.

The die 32 is used to shape the cross-section of the elongate element 20.

In a variant not shown, the supply means 18 are means for distributing an elongate element already formed, for example from a prepreg tape reel.

The winding means 22 comprise means 34 for applying the elongate element 20 on the master model 24 and means 36 for driving in rotation the master model 24 with respect to the application means 34.

The shape and dimensions of the master model 24 are intended to provide the wound elongate element 20 with the general shape of a continuous ring and with dimensions that allow the wound elongate element 20 to form the insert 2. The shape of the insert 2 is such that it extends through the body 4. The dimensions of the insert 2 are such that it extends through at least two zones to be reinforced, preferably through the five zones to be reinforced of the tailgate 1.

The application means 34 comprise a roller 38 for guiding and applying the elongate element 20 on the master model 24.

To do this, the roller 38 guides the elongate element 20 as it leaves the die 32 still hot, placing it against the edge 40 of the master model 24, while pressing it gently against this edge 40 to apply it firmly.

As shown on FIG. 3, the contour of the master model 24 coincides substantially with the desired path of the insert 2 in the tailgate 1, in other words it has the general shape of a continuous ring. Thus, the elongate element 20 applied on its edge 40 will have a similar shape.

Note that in the example described, the means 36 for driving in rotation are formed by a part of the arm 42 of the robot 25 which carries the master model 24.

The means 36 for driving in rotation can rotate the master model 24 so as to place any part of the edge 40 opposite the roller 38, which is fixed, to apply the elongate element 20 continuously against the edge 40.

This rotational movement is represented by the arrow R on FIG. 3.

The robot 25 is, for example, a six-axis robot normally used in the automotive industry, this type of robot generally comprising means adapted to perform the rotation described above.

For example, a robot allowing deposition at a speed of about 1 meter per second will be chosen. For a motor vehicle tailgate, the perimeter of an insert will be between 1 and 7 meters for example, and will be about 20 mm thick for example. With tapes about 0.2 mm thick for example, the tape will be deposited by making ten turns around the master model to obtain a thickness of about 20 mm. In another example, three to five turns will be made around the master model. Depending on the desired thickness, the winding time will be between 15 to 50 seconds for example.

In a variant not shown, the application means 34 rotate around a fixed master model 24. In this case, the master model 24 can be rotated about itself at a variable angle with respect to the application means 34 to facilitate deposition.

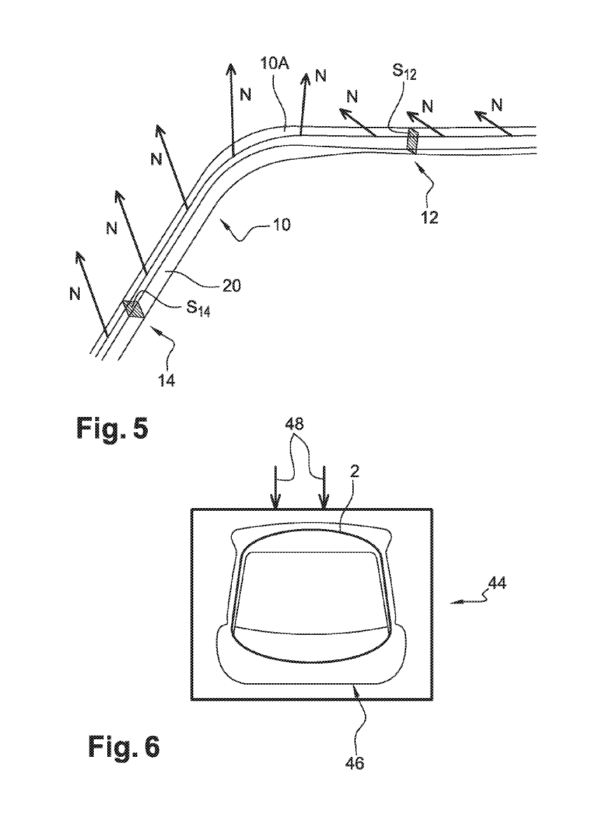

FIG. 5 shows a portion of the elongate element 20 once it has been applied on the master model 24.

During application on the master model 24, the orientation of a surface defining the cross-section of the elongate element 20 around a neutral fiber of this elongate element 20 is varied so that this surface is intended to extend through the opening panel zones 10, 12, 14 to be reinforced with different orientations.

In the example shown on this figure, the element 20 has a polygonal, more particularly square, cross-section.

Thus, during application on the master model 24, the orientation of the sides of the elongate element 20 is varied so that these sides are intended to extend through the zones 10 to be reinforced of the opening panel 1 with different orientations.

Thus, the side S₁₄ intended to extend through the zone 14 to be reinforced has a different orientation from the side S₁₂ intended to extend through the zone 12 to be reinforced.

The orientation of the sides of the elongate element 20 varies, as can be seen on FIG. 5, when winding the elongate element on the master model, in particular during the path separating zones to be reinforced. Consequently, the normal N to one of the surfaces of the elongate element (in this case its upper surface 10A) changes direction, by pivoting about a neutral fiber of the elongate element 10, between the zone 14 to be reinforced and the zone 12 to be reinforced.

The installation also comprises means 44 for overmolding the body 4 around the insert 2 to form the tailgate 1.

These overmolding means 44 comprise in particular a mold, in a cavity 46 in which the insert 2 is intended to be placed. The overmolding means further comprise means 48 for injecting (shown schematically on FIG. 6) in the mold the material intended to form the body 4 of the tailgate, i.e. a thermoplastic polymer in this example.

Note that other means of distributing the material intended to form the body 4 of the tailgate can be used, such as overmolding means, if necessary by compression. The insert 2 can also be assembled directly by gluing or screwing on the opening panel 1.

We will now describe the main steps related to the invention of the method for the production of the insert 2, this method being implemented by the installation described above.

Firstly, an elongate element 20 made of composite material is formed using the supply means 18 described above, preferably by pultrusion through the die 32 for shaping the cross-section of the elongate element 20.

In variants, for example in order to increase the cross-section of the elongate element 20 locally at the zones to be reinforced, the cross-section of this elongate element 20 is varied.

An elongate element 10 of variable cross-section can be provided for example by tapes of fibers impregnated by a matrix material when applying them on the master model 24, the variation in cross-section being obtained by superimposing and/or folding the tapes.

Optionally, the fiber tapes can be pre-impregnated before being applied on the master model 24, more matrix being added if necessary when applying these tapes on the master model 24.

Those skilled in the art will know how to provide, depending on the embodiments chosen, application means 34 adapted to heat and/or impregnate with resin, for example a polyamide resin, the elongate element 20, cut it, or fold it.

Reinforcing parts alternating with connecting parts are therefore created in the insert 2, the connecting parts being thinner than the reinforcing parts. The reinforcing parts are intended to extend through the zones 10, 12, 14 to be reinforced of the tailgate.

Then, using the winding means 22 described above, a coil is formed by winding the elongate element 20 around the master model 24 which has the required shape.

To do this, the master model 24 is carried by the robot arm 42 and this master model 24 is rotated relative to the roller 38 of the application means 34 using the means 36 for driving in rotation which form part of the robot 25. The roller 38 thus guides the hot elongate element 20 against the edge 40 of the master model 24 while pressing it gently against the edge 40 to apply it firmly.

During this step, the master model 24 provides the coil with the general shape of a continuous ring and with dimensions that allow the resulting coil to form the insert 2 intended to extend through the zones 10, 12, 14 to be reinforced of the tailgate.

Finally, the elongate element 20 thus wound on the master model 22 is allowed to cool until it is stiff enough to be removed from the master model 24 and then placed in a mold.

In the embodiment shown on the figures, to produce the tailgate 1 made of composite material, the insert 2 thus obtained is placed in a cavity 46 of the mold and the material comprising at least one polymer is distributed in the mold, for example using the injection means 48, to form the body 4 overmolded on the insert 2.

The tailgate 1 is thus obtained, in which the insert 2, with the general shape of a continuous ring, extends through all the zones to be reinforced of the tailgate 1.

Alternatively, the material comprising at least a polymer can be overmolded, if necessary by compression, in the mold to form the body 4 overmolded on the insert 2, or the insert 2 assembled directly on the opening panel 1 by gluing or screwing.

According to another embodiment not shown, after cooling the elongate element 20 thus wound on the master model 22, the insert 2 thus obtained is cut off in order to separate the parts that are intended to extend through at least two zones 10, 12, 14 to be reinforced.

The parts of the insert 2 are then placed in the cavity 46 of the mold opposite the zones 10 to be reinforced and the material comprising at least one polymer is distributed in the mold, for example using the injection means 48, to form the body 4 overmolded on the insert 2.

Alternatively, the material comprising at least one polymer can be overmolded, if necessary by compression, in the mold to form the body 4 overmolded on the insert 2, or the parts of the insert 2 can be assembled directly on the opening panel 1 by gluing or screwing opposite the zones 10 to be reinforced.

The invention is not limited to the embodiment described and other embodiments will be clearly apparent to those skilled in the art.

In particular, the method and installation described can be used to produce motor vehicle opening panels other than tailgates, for example side doors.

1. A method for production of an insert for a motor vehicle opening panel, wherein an elongate element is formed from a composite material and a coil is formed by winding the elongate element around a master model, the master model providing the coil with a shape of a continuous ring and with dimensions that allow the coil to form an insert equipped with at least two parts that are intended to extend respectively through at least two separate opening panel zones to be reinforced.

2. The method according to claim 1, wherein the elongate element is wound around the master model by turning the master model with respect to application means for applying the elongate element on the master model.

3. The method according to claim 1, wherein the elongate element being shaped by pultrusion through a die for shaping a cross-section of the elongate element.

4. The method according to claim 1, wherein a cross-section of the elongate element which is wound on the master model to create reinforcing parts alternating with connecting parts in the insert is varied, the reinforcing parts being intended to extend through the opening panel zones to be reinforced, the connecting parts being thinner than the reinforcing parts.

5. The method according to claim 1, wherein the composite material comprises a reinforcing material embedded in a matrix, for example a reinforcing material of glass or carbon fibers embedded in a polyamide matrix.

6. The method according to claim 1, wherein the insert is cut off in order to separate the two parts that are intended to extend through the two zones to be reinforced.

7. The method according to claim 1, wherein an orientation of a surface defining a cross-section of the elongate element around a neutral fiber of this elongate element is varied so that this surface is intended to extend through the opening panel zones to be reinforced with different orientations.

8. The method according to claim 7, wherein, the elongate element having a polygonal cross-section, for example rectangular, an orientation of sides of the elongate element is varied so that the sides of the elongate element are intended to extend through the opening panel zones to be reinforced with different orientations.

9. A method for production of a motor vehicle opening panel made of composite material, this opening panel comprising a body overmolded on an insert, wherein
an insert made of composite material is formed using a method according to any one of the preceding claims;
the insert is placed in a mold; and
a material comprising at least one polymer is distributed, preferably by injection, in the mold to form the body overmolded on the insert.

10. The method according to claim 9, the opening panel being a motor vehicle tailgate.

11. An installation for production of an insert of a motor vehicle opening panel, the installation comprising:
means for supplying an elongate element made of composite material; and
winding means for winding the elongate element around a master model, the master model having a shape and dimensions to provide the wound elongate element with a shape of a continuous ring and with dimensions that allow the wound elongate element to form an insert equipped with at least two parts that are intended to extend respectively through at least two separate opening panel zones to be reinforced.

12. The installation according to claim 11, the winding means comprising application means for applying the elongate element on the master model and means for driving in rotation the master model with respect to the application means for applying the elongate element on the master model.

13. The installation according to claim 12, wherein the application means comprise a roller for guiding and applying the elongate element on the master model.

14. The installation according to claim 12, further comprises a robot for carrying the master model, the means for driving in rotation the master model being formed by a part of an arm of the robot.

15. A motor vehicle opening panel production apparatus, comprising:
the installation according to claim 11;
a mold in which the insert is to be placed; and
means for distributing material comprising at least one polymer in the mold, preferably injection means.

16. A motor vehicle opening panel made of composite material, comprising an insert made of composite material comprising a reinforcing material embedded in a matrix, the insert having a shape of a continuous ring extending through at least two separate opening panel zones to be reinforced.

17. The motor vehicle opening panel according to claim 16, further comprising an opening, the insert surrounding the opening.

18. The motor vehicle opening panel according to claim 16, the opening panel forming a tailgate of the vehicle and comprising at least two separate zones to be reinforced forming support means selected from:
locking means;
pivoting means; and
means for anchoring means for assisting operation of the tailgate.
